(19) United States
(12) Patent Application Publication
(10) Pub. No.: US 2012/0183166 A1
(43) Pub. Date: Jul. 19, 2012

(54) METHOD AND APPARATUS FOR FITTING HEARING DEVICES

(75) Inventors: Philipp Schneider, Zurich (CH); Robert Baur, Mannedorf (CH)

(73) Assignee: PHONAK AG, Stafa (CH)

(21) Appl. No.: 13/497,112

(22) PCT Filed: Sep. 29, 2009
(86) PCT No.: PCT/EP09/62618

§ 371 Date: Mar. 20, 2012

(51) Int. Cl. H04R 25/00

(52) U.S. Cl. 381/314

(57) ABSTRACT

A method for adjusting a second hearing device in dependence of a first hearing device is proposed. Therein, the first hearing device has been, by means of a first fitting system, individually adjusted to needs and preferences of a specific hearing device user. The method comprises the steps of
a1) providing data (165) related to the first hearing device;
a2) providing data (155) related to the first fitting system;
d1′) adjusting the second hearing device in dependence of the data (165) related to said first hearing device and of the data (155) related to said first fitting system.

The corresponding apparatus is disclosed, too. A fitting can be transferred from the first hearing device to the second hearing device.

### TECHNICAL FIELD

The invention relates to the field of hearing devices, more particularly to the fitting of hearing devices. It relates to a method and an apparatus for adjusting a hearing device and more particularly to a method and an apparatus for manufacturing an adjusted second hearing device adjusted in dependence of a first hearing device.

Under a hearing device, a device is understood, which is worn in or adjacent to an individual's ear with the object to improve the individual's audiological perception. Such improvement may also be barring acoustic signals from being perceived in the sense of hearing protection for the individual. If the hearing device is tailored so as to improve the perception of a hearing impaired individual towards hearing perception of a normal-hearing individual, then we speak of a hearing-aid device. With respect to the application area, a hearing device may be applied, e.g., behind the ear, in the ear, completely in the ear canal or may be implanted.

A hearing system comprises at least one hearing device. In case that a hearing system comprises at least one additional device, all devices of the hearing system are operationally connectable within the hearing system. Typically, said additional devices such as another hearing device, a remote control or a remote microphone, are meant to be worn or carried by said individual.

Under audio signals we understand electrical signals, analogue and/or digital, which represent sound.

### BACKGROUND OF THE INVENTION

A hearing device is of very limited use for a hearing device user if it is not specifically adjusted to the hearing needs and preferences of the hearing device user. This applies in particular to hearing-aid devices.

The corresponding individual adjusting is referred to as “fitting”.

In many cases, in particular when it comes to hearing-aid devices, the fitting can be roughly divided into two phases. In a first phase, a fitting rationale is applied to an audiogram of the hearing device user and possibly additional data. The result can be referred to as baseline-fitting or initial fitting. A fitting rationale such as Phonak Digital, NAL-NL1, DSL-i/o or others, can be considered an algorithm that can be fed with audiogram data and possibly additional data, whereupon it outputs parameter settings, more particularly transfer curves such as a multitude of frequency-dependent amplifications for various input levels or the like. Adjusting the hearing device according thereto, will usually result in a relatively good initial fitting (good initial settings), but many further adjustments are usually necessary for a satisfactory hearing experience. These further adjustments, making up the second fitting phase, is referred to as “fine-tuning”. Fine-tuning requires a lot of experience and time and therefore patience from both, the hearing device user and the fitter.

There are situations when a hearing device user content with the fitting of his hearing device has to use a different hearing device. E.g., when the old hearing device is broken and cannot be repaired and the old hearing device type is not available anymore. Or, when the hearing device user needs a more powerful or wants a different-looking hearing device. In such cases, today, it is not well possible to transfer the fitting from the old hearing device to the new hearing device such that a suitable hearing experience, e.g., approximately the same as with the old hearing device, is achieved using the new hearing device. Instead, a new baseline fitting and a new fine-tuning has to be carried out.

In EP 1 453 358 A2, it is suggested to derive new settings for a new hearing-aid device from data received from the old hearing-aid device and audiometric measurements. Various variants to do so are disclosed, e.g., involving simulating audio output signals of the new hearing-aid device, or determining (measuring) transfer characteristics of the old hearing-aid device in order to reproduce these in the new hearing-aid device. EP 1 453 358 A2 discloses that by means of the suggested method, the use of fitting rationales and the so-obtained baseline-fitting can be dispensed with; the application of fitting rationales to audiogram data is, according to EP 1 453 358 A2, replaced by the suggested method.

US 2006/0098831 A1 proposes to apply the well-known copy-paste or drag-and-drop process common in most computer operating systems, for instructing a software to copy settings of one hearing device to another hearing device.

DE 102 35 501 A1 proposes to use a personal storage medium such as a chip card, for storing settings of a configured hearing-aid device. E.g., in case the hearing-aid device is defect, the settings data can be transferred from the storage medium to a new hearing-aid device.

It is desirable to provide an alternative way of transferring data from one hearing device fitted for a specific user to another hearing device to be used by that specific user.

### SUMMARY OF THE INVENTION

One object of the invention is to create a new method for adjusting a second hearing device in dependence of a first hearing device, wherein said first hearing device has been, by means of a first fitting system, individually adjusted to needs and preferences of a specific hearing device user. As well, a method for manufacturing an adjusted second hearing device adjusted in dependence of a first hearing device, wherein said first hearing device has been, by means of a first fitting system, individually adjusted to needs and preferences of a specific hearing device user shall be provided.

In addition, a corresponding apparatus for adjusting a second hearing device in dependence of a first hearing device, and a corresponding computer program product, and a corresponding computer-readable medium, and a corresponding use of data related to a first fitting system shall be provided.

Another object of the invention is to provide the possibility to factually provide a way for transferring a fitting from a first hearing device to a second hearing device.

Another object of the invention is to do so without the need to carry out cumbersome acoustic measurements at the first hearing device.

Another object of the invention is to provide a fully computer-based/software-based solution to do so.

Another object of the invention is to provide a largely or fully automated way to do so.

Another object of the invention is to provide a possibility to do so, which can very flexibly be applied to very many hearing devices, not only to different models of the same brand, but even to hearing device of different manufacturers.

Another object of the invention is to provide a possibility to do so, which allows, after transferring a fitting from a first hearing device to a second hearing device, to further fine-tune the second hearing device, and in particular to further fine-tune the second hearing device in a comfortable and/or well-defined way.

Another object of the invention is to provide a possibility to render largely or fully superfluous the efforts required for carrying out a full fine-tuning when adjusting a second hearing device to the needs and preferences of a specific hearing device user, by profiting from a fitting that has been carried out for adjusting a first hearing device to the needs and preferences of the same hearing device user.

Further objects emerge from the description and embodiments below.

At least one of these objects is at least partially achieved by apparatuses and methods and uses and computer program products and computer-readable media according to the patent claims.

The inventors have realized that focussing practically solely on the properties of the first hearing device, may it involve the read-out parameter settings or acoustic measurements thereof or both, is unlikely to render satisfactory results. The inventors further realized that, even if parameter settings for the second hearing device have been derived with which it sounds very similar to the first hearing device, this is of very limited use, since it is likely that sooner or later, it will be desirable to carry out further adjustments of the second hearing device.

The inventors found that it is very useful to take into consideration the fitting systems, more particularly the first fitting system by means of which the first hearing device has been fitted, when trying to transfer a fitting from one hearing device to another. Further thoughts and finding of the inventors will become apparent from other parts of this patent application.

The method for manufacturing an adjusted second hearing device adjusted in dependence of a first hearing device, wherein said first hearing device has been, by means of a first fitting system, individually adjusted to needs and preferences of a specific hearing device user, comprises the steps of
a1) providing data related to said first hearing device;
a2) providing data related to said first fitting system;
d1′) adjusting said second hearing device in dependence of said data related to said first hearing device and of said data related to said first fitting system.

Through this, excellent results have achieved in transferring a fitting from one hearing device to another.

In a certain view, the method is a method for adjusting a second hearing device in dependence of what is mentioned above and comprising the steps mentioned above.

In one embodiment, said data related to said first hearing device are data descriptive of properties of said first hearing device.

In one embodiment which may be combined with the before-addressed embodiment, said data related to said first fitting system are data descriptive of properties of said first fitting system.

In one embodiment which may be combined with one or more of the before-addressed embodiments, the method is carried out in a substantially automated fashion.

In one embodiment which may be combined with one or more of the before-addressed embodiments, said data related to said first fitting system are data descriptive of adjustments, more particularly parameter adjustments, carried out during said adjusting said first hearing device, more particularly carried out in said first fitting system.

In one embodiment which may be combined with one or more of the before-addressed embodiments, said data related to said first fitting system comprise data descriptive of information not required by said first hearing device during its operation, such as, e.g., data indicating that hearing program 3 is a hearing program for listening to music. For operating the first hearing device, it is usually sufficient to “know” that a certain program is program number 3, but whether this program 3 is adapted for listening to music or rather for listening to speech in a noisy environment is not important for operating the hearing device, but is a valuable information when adjusting the second hearing device.

A fitting system usually is a computer system (such as a personal computer) with a fitting software executed or executable therein.

In one embodiment which may be combined with one or more of the before-addressed embodiments, a second fitting system is used for adjusting said second hearing device, said method further comprises the step of
d2′) adjusting said second fitting system in dependence of said data related to said first hearing device and of said data related to said first fitting system.

This way, also the second fitting system is adjusted, which can allow to carry out further adjustments to the second hearing device, in particular in a comfortable way.

In one embodiment which may be combined with one or more of the before-addressed embodiments, said data related to said first hearing device comprise data descriptive of hearing device parameter settings of said first hearing device individually adjusted for said specific hearing device user and, in addition, data descriptive of properties of said first hearing device which are not individual to said specific hearing device user.

Said data descriptive of hearing device parameter settings may comprise e.g., instructions to the hearing device's signal processor which result is a certain compression ratio in a certain frequency and input volume range under certain conditions.

Said properties of said first hearing device may comprise e.g., the number of microphones, the number of programmable hearing programs, or data describing MLE (microphone location effects, which are represented by a particular amplification vs. frequency curve).

In one embodiment which may be combined with one or more of the before-addressed embodiments, for hearing device parameters the setting of which are mentioned, it applies that most of these parameters or they all are electronically adjustable, typically digitally.

In one embodiment which may be combined with one or more of the before-addressed embodiments, said data related to said first fitting system comprise data descriptive of fitting system parameter adjustments carried out during adjusting said first hearing device using said first fitting system and, in addition, data descriptive of properties of said first fitting system which are not individual to said specific hearing device user.

Said data descriptive of fitting system parameter adjustments may comprise data representative of final parameter settings of parameters of the fitting system achieved during adjusting said first hearing device using said first fitting system; alternatively or in addition, said data descriptive of fitting system parameter adjustments comprise data representative of a sequence (such as an order in time) in which fitting system parameter adjustments have been carried out during adjusting said first hearing device using said first fitting system.

It is emphasized that one has to distinguish between hearing device parameters (and the parameter settings belonging thereto) and fitting system parameters (and the parameter settings belonging thereto). This, although these parameters and settings, respectively, are, of course, linked to each other, since making an adjustment in the fitting system is usually done in order provoke—after the respective data have been transferred to the hearing device—a change in one or more parameters of the hearing device. But, in between, some data conversion has to take place mapping the adjustment carried out in the fitting system into adjustments in the hearing device. The fitting system parameters are prevailingly parameter closely related to psycho-acoustic magnitudes or physically measurable variables, whereas the hearing device parameters are prevailingly magnitudes used by a signal processor and/or by a controller of the hearing device.

In one embodiment which may be combined with one or more of the before-addressed embodiments, a second fitting system is used for adjusting said second hearing device, and said method comprises the steps of
a) providing a first data set comprising first hearing device modelling data and first fitting modelling data;
   wherein said first hearing device modelling data comprise
   first hearing device settings description data descriptive of hearing device settings, in particular parameter settings, of said first hearing device individually adjusted for said specific hearing device user; and, in addition,
   first hearing device system description data descriptive of properties, in particular of hardware and software properties, of said first hearing device which are not individual to said specific hearing device user; and
      wherein first fitting modelling data comprise
   first fitting-adjustments description data descriptive of fitting system parameter adjustments carried out during adjusting said first hearing device using said first fitting system; and, in addition,
   first fitting system description data descriptive of properties of said first fitting system which are not individual to said specific hearing device user;
b1) providing second hearing device system description data descriptive of properties, in particular of hardware and software properties, of said second hearing device which are not individual to said specific hearing device user;
b2) providing second fitting system description data descriptive of properties of said second fitting system which are not individual to said specific hearing device user;
c1) deriving, in dependence of
   said first data set;
   said second hearing device system description data; and
   said second fitting system description data;
second hearing device settings description data descriptive of hearing device settings, in particular parameter settings, applicable to said second hearing device; and
d1) adjusting said second hearing device according to said second hearing device settings description data.

An embodiment with these features shall be referred to as “embodiment 5”.

Such an embodiment allows to achieve very good fitting result.

It is possible to interpret step a) as a more concrete embodiment of steps a)1 and a2).

In one embodiment which may be combined with embodiment 5, said hardware properties comprise, e.g., data describing the formfactor of the hearing device (such as BTE, ITC, CIC, . . . ), or the further-above mentioned MLE data, or data indicative of which interfaces to the outside are comprised in the hearing device.

Said software of the hearing device typically comprises or is the hearing device firmware.

In one embodiment which may be combined with one or more of the before-addressed embodiments referring to embodiment 5, said software (or firmware) properties may comprise, e.g., data indicative of whether or not a feedback canceller is provided in the hearing device, or data indicative of the number of programmable hearing programs in the hearing device.

In one embodiment which may be combined with one or more of the before-addressed embodiments referring to embodiment 5, said first fitting-adjustments description data are data descriptive of information not required by said first hearing device during its operation.

In one embodiment which may be combined with one or more of the before-addressed embodiments referring to embodiment 5, said first fitting adjustments description data comprise at least one of the group consisting of
first fitting-rationale input data (comprising first audiogram data of said specific hearing device user), and data descriptive of a first fitting rationale applied to said first fitting-rationale input data during adjusting said first hearing device; and
data descriptive of the result obtained during fitting said first hearing device by applying a first fitting rationale to first fitting-rationale input data (comprising first audiogram data of said specific hearing device user).

Therein, said “data descriptive of a fitting rationale” may describe, e.g., the fitting rationale itself, or name and version of the fitting rationale, or both.

Usually, said fitting-rationale input data comprise, besides first audiogram data of said specific hearing device user, e.g., further diagnostic data, data describing properties (such as the size) of the vent of the hearing device, the formfactor of the hearing device, the age of the hearing device user, the amount of experience the user has with hearing devices or further data.

In one embodiment which may be combined with one or more of the before-addressed embodiments referring to embodiment 5, the method comprises the steps of
c2) deriving, in dependence of
   said first data set;
   said second hearing device system description data; and
   said second fitting system description data;
second fitting-adjustments description data descriptive of fitting system parameter adjustments applicable to said second fitting system; and
d2) carrying out adjustments of said second fitting systems according to said second fitting-adjustments description data.

This way, a suitably adjusted second fitting system is provided, allowing for readily executable further adjustments and optimizations of the hearing device by means of the second fitting system.

In one embodiment which may be combined with one or more of the before-addressed embodiments referring to embodiment 5, the method comprises the step of
e1) creating second hearing device modelling data comprising said second hearing device settings description data and said second hearing device system description data.

In one embodiment which may be combined with one or more of the before-addressed embodiments referring to embodiment 5, the method comprises the step of
e2) creating second fitting modelling data comprising said second fitting-adjustments description data and said second fitting system description data.

In one embodiment referring to the two before-addressed embodiments, the method comprises the step of
f) creating a second data set comprising said second hearing device modelling data and said second fitting modelling data.

In one embodiment referring to the before-addressed embodiment, the method comprises the step of
d) carrying out adjustments of said second fitting system in dependence of said second data set.

In one embodiment which may be combined with one or more of the before-addressed embodiments referring to embodiment 5, said first data set is written in a fitting description language which is a computer language by means of which fitting processes and environments are describable in a generalized way.

More particularly, therein, “fitting processes” mainly refer to adjustments (changes of parameter settings) carried out during the fitting and to the corresponding parameter settings, be it parameter settings of the fitting system or of the hearing device, and “fitting environment” refers to given hardware and software properties (of the fitting system and of the hearing device).

In one embodiment referring to said fitting description language, said fitting description language is a language into which and from which a large number of different data structures or formats for corresponding data sets referring to different hearing device models and different fitting systems can be transformed.

In one embodiment which may be combined with the before-addressed embodiments referring to said fitting description language, said fitting description language is not characteristic for a specific hearing device.

In one embodiment which may be combined with the before-addressed embodiments referring to said fitting description language, said fitting description language is not characteristic for a specific fitting system.

In particular, said fitting description language is to be understood as a “language” in the sense in which, e.g., HTML (hypertext mark-up language) is a “language”. HTML is a computer language by means of which world-wide-web pages are describable.

In one embodiment which may be combined with one or more of the before-addressed embodiments referring to embodiment 5, said first data set has a generalized data structure, in particular wherein said generalized data structure is a data structure into which a large number of different data structures for corresponding data sets referring to different hearing device models and different fitting systems can be converted, in particular wherein said generalized data structure is not characteristic for a specific hearing device, and in particular, wherein said generalized data structure is not characteristic for a specific fitting system.

In one embodiment which may be combined with the before-addressed embodiments referring to said fitting description language, the method comprises the step of
g) obtaining said first data set written in said fitting description language from a corresponding data set having a different data structure or data format characteristic for said first hearing device and/or for said first fitting system.

In one embodiment which may be combined with the before-addressed embodiments referring to said fitting description language, the method comprises the step of
h) generating said first data set written in said fitting description language from said corresponding data set, e.g., by translating or transforming or converting.

In one embodiment referring to one or both of the two before-addressed embodiments, the said corresponding data set comprises at least approximately the same information as said first data set, but in a different form.

In one embodiment referring to one or more of the before-addressed three embodiments, the information in said first data set is at least substantially deducible from the information comprised in said corresponding data set.

It is possible to approximately or fully separately treat said first hearing device modelling data and said first fitting modelling data comprised in the first data set in step g) or in the first data set in step h).

In one embodiment referring to step g), said first hearing device modelling data is written in a hearing device modelling description language which is a computer language by means of which hearing device properties (individualized and non-individualized) are describable in a generalized way, and/or said first fitting modelling data is written in a fitting system modelling description language which is a computer language by means of which fitting systems and adjustments carried out in the fitting systems are describable in a generalized way, wherein step g) comprises one or both of the following steps
g1) obtaining said first hearing device modelling data from corresponding hearing device modelling data having a data structure or data format characteristic for said first hearing device; and/or
g2) obtaining said first fitting modelling data from corresponding fitting modelling data having a data structure or data format characteristic for said first fitting system; and
   in particular, the method comprises one or both of the following steps
h1) generating said first hearing device modelling data written in said hearing device modelling description language from said corresponding hearing device modelling data, e.g., by translating or transforming or converting; and/or
h2) generating said first fitting modelling data written in said fitting system modelling description language from said corresponding fitting modelling data, e.g., by translating or transforming or converting.

It is possible to provide that said hearing device modelling description language is fully or substantially identical with said fitting description language.

Alternatively, it is possible to provide that said hearing device modelling description language is different from said fitting description language.

It is possible to provide that said fitting system modelling description language is fully or substantially identical with said fitting description language.

Alternatively, it is possible to provide that said fitting system modelling description language is different from said fitting description language.

In one embodiment which may be combined with one or more of the before-addressed embodiments referring to embodiment 5, data in said first data set are logically arranged in a tree structure. This may be accomplished, e.g., by correspondingly structurized language.

In one embodiment which may be combined with one or more of the before-addressed embodiments referring to embodiment 5, said first hearing device modelling data are logically arranged in a tree structure.

In one embodiment which may be combined with one or more of the before-addressed embodiments referring to embodiment 5, said first fitting modelling data are logically arranged in a tree structure.

In one embodiment which may be combined with one or more of the before-addressed embodiments referring to a tree structure, in one or more of said tree structures, for a multitude of parameters described therein, in particular for substantially all parameters described therein, it applies that there is in the tree structure a parent node containing data descriptive of the parameter itself (e.g., “number of programs” and “compression ratio”) having a child node containing data descriptive of the available parameter settings (e.g., “2 to 4” and “1:1 to 1:100”, respectively) and another child node containing data descriptive of the actual parameter settings (e.g., “2” and “1:32”, respectively).

In one embodiment which may be combined with one or more of the before-addressed embodiments referring to embodiment 5, said first fitting-adjustments description data comprise first baseline-fitting data and, in addition, first fine-tuning data, wherein said baseline-fitting data are obtained by applying a fitting rationale to first fitting-rationale input data, and wherein said first fine-tuning data are descriptive of additional fitting system parameter adjustments carried out during adjusting said first hearing device using said first fitting system after applying said baseline-fitting data. Typically, said first fitting-rationale input data comprise first audiogram data of said specific hearing device user.

In one embodiment referring to the before-addressed embodiment, said first baseline-fitting data comprise at least one of the group consisting of
first fitting rationale input data and data descriptive of a first fitting rationale applied to said first fitting rationale input data during adjusting said first hearing device; and
data descriptive of a first result obtained, during fitting said first hearing device, by applying a first fitting rationale to first fitting rationale input data;
   in particular wherein the method comprises the steps of
j) applying a second fitting rationale to second fitting rationale input data, obtaining a second result; and, in particular,
k) comparing said first result with said second result;
   in particular, wherein said second hearing device settings description data depend on the result of said comparison, and wherein said second fitting rationale is either identical with or different from said first fitting rationale, and wherein said second fitting rationale input data are either identical with or different from said first fitting rationale input data.

By means of that, it is possible to determine the fine-tuning applied during the fitting of the first hearing device and, moreover, to apply a fine-tuning resulting in substantially the same overall tuning in the fitting of the second hearing device in a particularly elegant way.

In particular, said first fitting rationale input data comprises first audiogram data of said specific hearing device user.

In particular, said second fitting rationale input data comprises second audiogram data of said specific hearing device user.

More particularly, said second fitting rationale input data comprise second audiogram data of said specific hearing device user, and said first fitting rationale input data comprise first audiogram data of said specific hearing device user, and said first audiogram data are either identical with or different from said first audiogram data.

Note that fitting rationales are considered different not only if they are of different origin such as DSL-i/o and Phonak Digital are different, but also if they are merely different versions such as version 2.3 and Version 2.3.2.

In one embodiment referring to the before-addressed embodiment, the method comprises the steps of
c2′) deriving, in dependence of
   said first data set;
   said second hearing device system description data;
   said second fitting system description data; and
   said result of said comparison;
second fitting-adjustments description data descriptive of fitting system parameter adjustments applicable to said second fitting system; and, in particular,
d2) carrying out adjustments of said second fitting systems according to said second fitting-adjustments description data.

This way, the fine-tuning of the second hearing device is not only easily accomplished, but further—additional—adjustments can readily be carried out in the second fitting system.

In one embodiment which may be combined with one or more of the before-addressed embodiments, the type of hearing device of said first hearing device is a different from the type of hearing device of said second hearing device, e.g., different versions or different models or different brands.

In one embodiment which may be combined with one or more of the before-addressed embodiments, said first hearing device is a hearing-aid device, and said second hearing device is a hearing-aid device.

In one embodiment which may be combined with one or more of the before-addressed embodiments, said first fitting system is different from said second fitting system, in particular, a fitting software of said first fitting system is different from a fitting software of said second fitting system. Therein, a fitting software is different from another fitting software not only if they are of different origin (such as iPFG and U:Fit), e.g., provided by different hearing device manufacturers, but also if they are merely different versions such as version 2.3 and Version 2.3.2.

The apparatus is an apparatus for adjusting a second hearing device in dependence of a first hearing device,

wherein said first hearing device has been, by means of a first fitting system, individually adjusted to needs and preferences of a specific hearing device user, said apparatus comprises a fitting transfer unit structured and configured for
receiving data related to said first hearing device;
receiving data related to said first fitting system; and
deriving, in dependence of said data related to said first hearing device and said data related to said first fitting system, second hearing device settings description data descriptive of hearing device settings applicable to said second hearing device, in particular parameter settings for said second hearing device.

In one embodiment of the apparatus, said fitting transfer unit is structured and configured for
outputting said second hearing device settings description data;
   and in particular structured and configured for
outputting said second hearing device settings description data to said second hearing device.

In one embodiment of the apparatus which may be combined with the before-addressed embodiment, said fitting transfer unit is structured and configured for
i) receiving a first data set comprising first hearing) device modelling data and first fitting modelling data;
   wherein said first hearing device modelling data comprise
   first hearing device settings description data descriptive of hearing device settings, in particular parameter settings, of said first hearing device individually adjusted for said specific hearing device user; and, in addition,
   first hearing device system description data descriptive of properties, in particular of hardware and software properties, of said first hearing device which are not individual to said specific hearing device user; and
      wherein first fitting modelling data comprise
   first fitting-adjustments description data descriptive of fitting system parameter adjustments carried out during adjusting said first hearing device using said first fitting system; and, in addition,
   first fitting system description data descriptive of properties of said first fitting system which are not individual to said specific hearing device user;
ii) receiving second hearing device system description data descriptive of properties, in particular of hardware and software properties, of said second hearing device which are not individual to said specific hearing device user;
iii) receiving second fitting system description data descriptive of properties of a second fitting system suitable for adjusting said second hearing device, wherein said second fitting system description data are not individual to said specific hearing device user;
iv) deriving said second hearing device settings description data in dependence of
   said first data set;
   said second hearing device system description data; and
   said second fitting system description data.

In one embodiment of the apparatus, the apparatus comprises said second fitting system, in particular wherein said fitting transfer unit is comprised in said second fitting system.

The invention comprises apparatuses with features of corresponding methods according to the invention, and vice versa.

The advantages of the apparatuses basically correspond to the advantages of corresponding methods and vice versa.

The computer program product comprises program code for causing a computer to perform the steps of
A1) providing or receiving data related to a first hearing device;
A2) providing or receiving data related to a first fitting system, wherein said first hearing device has been, by means of said first fitting system, individually adjusted to needs and preferences of a specific hearing device user; and
C) deriving, in dependence of said data related to said first hearing device and of said data related to said first fitting system, second hearing device settings description data descriptive of hearing device settings applicable to a second hearing device, in particular parameter settings for said said second hearing device.

In one embodiment of the computer program product, said program code is configured to cause said computer to perform the step of
D1) adjusting said second hearing device in dependence of said second hearing device settings description data.

The invention comprises computer program products with features of corresponding methods and/or corresponding apparatuses according to the invention, and vice versa.

The advantages of the computer program products basically correspond to the advantages of corresponding apparatuses or methods and vice versa.

The computer-readable medium comprises program code as described in one of the computer program product embodiments.

The use is a use of data related to a first fitting system, in particular of data descriptive of properties of said first fitting system, for determining data for adjusting a second hearing device, wherein said first hearing device has been, by means of a first fitting system, individually adjusted to needs and preferences of a specific hearing device user.

In one embodiment of the use, said data related to said first fitting system comprise data descriptive of fitting system parameter adjustments carried out during adjusting said first hearing device using said first fitting system.

The invention comprises uses with features of corresponding methods and/or corresponding apparatuses according to the invention, and vice versa.

The advantages of the uses basically correspond to the advantages of corresponding apparatuses or methods and vice versa.

Viewed from a particular point of view, a method according to the invention can be seen in:

A method for adjusting a second hearing device in dependence of a first hearing device (or a method for manufacturing an adjusted second hearing device adjusted in dependence of a first hearing device), wherein said first hearing device has been, by means of a first fitting system, individually adjusted to needs and preferences of a specific hearing device user, wherein a second fitting system is used for adjusting said second hearing device, wherein the method comprises the steps of
a) providing a first data set comprising first hearing device modelling data and first fitting modelling data;
   wherein said first hearing device modelling data comprise
   first hearing device settings description data descriptive of hearing device settings, in particular parameter settings, of said first hearing device individually adjusted for said specific hearing device user; and, in addition,
   first hearing device system description data descriptive of properties, in particular of hardware and software properties, of said first hearing device which are not individual to said specific hearing device user; and
      wherein first fitting modelling data comprise
   first fitting-adjustments description data descriptive of fitting system parameter adjustments carried out during adjusting said first hearing device using said first fitting system; and, in addition,
   first fitting system description data descriptive of properties of said first fitting system which are not individual to said specific hearing device user;
b1) providing second hearing device system description data descriptive of properties, in particular of hardware and software properties, of said second hearing device which are not individual to said specific hearing device user;
b2) providing second fitting system description data descriptive of properties of said second fitting system which are not individual to said specific hearing device user;
c2) deriving, in dependence of
   said first data set;
   said second hearing device system description data; and
   said second fitting system description data;
second fitting-adjustments description data descriptive of fitting system parameter adjustments applicable to said second fitting system.

In this case, the aspect of determining data for adjusting the second fitting system is stressed. By means of a properly adjusted second hearing system, a properly adjustment of the second hearing device is readily obtained. As is immediately clear, most of the embodiments described above are also embodiments of this method; for reasons of conciseness, they will not be repeated here.

Viewed from a very particular point of view, a method according to the invention can be seen in:

A method for adjusting a second hearing device in dependence of a first hearing device (or a method for manufacturing an adjusted second hearing device adjusted in dependence of a first hearing device), wherein said first hearing device has been, by means of a first fitting system, individually adjusted to needs and preferences of a specific hearing device user, wherein a second fitting system is used for adjusting said second hearing device, and the method comprises the steps of
a) providing first hearing device system description data and first fitting modelling data;
   wherein said first hearing device system description data descriptive of properties, in particular of hardware and software properties, of said first hearing device which are not individual to said specific hearing device user; and
   wherein first fitting modelling data comprise
   first fitting-adjustments description data descriptive of fitting system parameter adjustments carried out during adjusting said first hearing device using said first fitting system; and, in addition,
   first fitting system description data descriptive of properties of said first fitting system which are not individual to said specific hearing device user;
b1) providing second hearing device system description data descriptive of properties, in particular of hardware and software properties, of said second hearing device which are not individual to said specific hearing device user;
b2) providing second fitting system description data descriptive of properties of said second fitting system which are not individual to said specific hearing device user;
c2″) deriving, in dependence of
   said first hearing device system description data;
   said first fitting modelling data
   said second hearing device system description data; and
   said second fitting system description data;
second fitting-adjustments description data descriptive of fitting system parameter adjustments applicable to said second fitting system.

Also in this case, the aspect of determining data for adjusting the second fitting system is stressed. Again, by means of a properly adjusted second hearing system, a properly adjustment of the second hearing device is readily obtained. But, in addition, the first hearing device settings description data are dispensed with; they can be reconstructed from the first fitting-adjustments description data. As is immediately clear, most of the embodiments described above are also embodiments of this method; for reasons of conciseness, they will not be repeated here.

Further embodiments and advantages emerge from the dependent claims and the figures.

### BRIEF DESCRIPTION OF THE DRAWINGS

Below, the invention is described in more detail by means of examples and the included drawings. The figures show schematically:

FIG. 1 a diagrammatical illustration of a method and an apparatus;

FIG. 2 an illustration of a data set useable in conjunction with the invention;

FIG. 3 a diagrammatical illustration of a method and an apparatus;

FIG. 4 a diagrammatical illustration of a method and an apparatus;

FIG. 5 a diagrammatical illustration of a method and an apparatus;

FIG. 6 a diagrammatical illustration of a detail of a method and an apparatus.

The reference symbols used in the figures and their meaning are summarized in the list of reference symbols. The described embodiments are meant as examples and shall not confine the invention.

### DETAILED DESCRIPTION OF THE INVENTION

Since many of the items discussed below are data with relatively long names, we shall for increased conciseness at least partially refer to these as “data” plus the corresponding reference symbol. In the list of reference symbols, all the names are listed, and in the section Summary of the Invention above, many details of the items discussed below have already been explained; for sake brevity and conciseness, the reader is asked to refer thereto. Furthermore, from the section Summary of the Invention above, the general meaning of “fitting system”, of “data set”, of “fitting modelling data”, of “hearing device modelling data”, of “fitting adjustments description data”, of “hearing device settings description data”, of “hearing device system description data”, of “fitting system description data”, of “fitting rationale input data”, of “fine-tuning data”, and of “baseline-fitting data” is clear and will become even clearer in the following, so that their respective meaning when referred to as a “first” or “second” or “new” or “generalized” is readily understood as well.

The problems which can be solved by means of the invention and the situations and circumstances in which it can be applied have been sufficiently discussed further above.

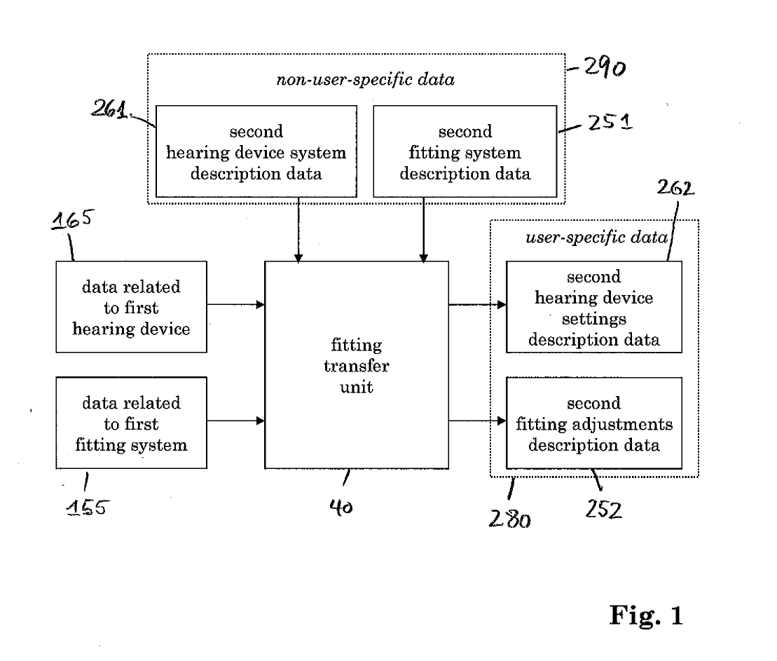

FIG. 1 shows a schematical simplified diagrammatical illustration of a method and an apparatus. A fitting transfer unit 40 plays a central role in a transfer of a fitting from a first hearing device (fitted for a specific user) to a second hearing device. It can be implemented as or in a fitting system, more particularly in a fitting software running on a computer. It could also be realized outside a fitting system, again using a computer and software, or using a programmed processor. The output could then, e.g., be transferred to a fitting system.

Fitting transfer unit 40 is fed with data 155 and 165, which characterize the first hearing device and its fitting, and with data 251 and 261, which characterize non-user-specific properties of the second hearing device (reference 290).

The output of fitting transfer unit 40 is data 252 and 262, wherein it is possible that only data 252 or only data 262 are outputted. These data 252,262 characterize user-specific data regarding the second hearing device and its fitting (reference 280).

With only data 262, it is possible to adjust the second hearing device in such a way that it sounds very much like the first hearing device.

With only data 252, the same will be possible, namely via a second fitting system, and moreover, further adjustments of the second hearing device are readily accomplished using the second fitting system an data 262.

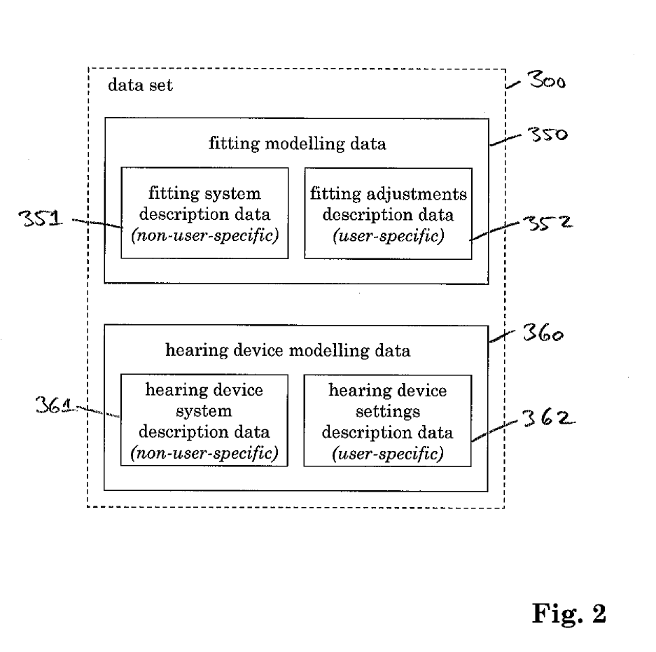

FIG. 2 shows an illustration of a data set useable in conjunction with the invention. Data sets comprising data such as those discussed in FIG. 1 can be divided and summed up, respectively, in the way shown in FIG. 2. Such a data set 300 can be used in conjunction with any hearing device, in particular with the first hearing device and said second hearing device.

Data set 300 comprises fitting modelling data 350 and hearing device modelling data 360. Fitting modelling data 350 comprise data 351 and data 352. Hearing device modelling data 360 comprise data 361 and 362.

As is readily understood, also with an eye on FIG. 1, for the first hearing device, preferably all of the data 351, 352, 361 and 362 are available as input for a conversion/algorithm as is implemented in fitting transfer unit 40, and for the second hearing device, this applies to data 351 and data 361. The sought output will be data 352 and/or data 362, preferably both.

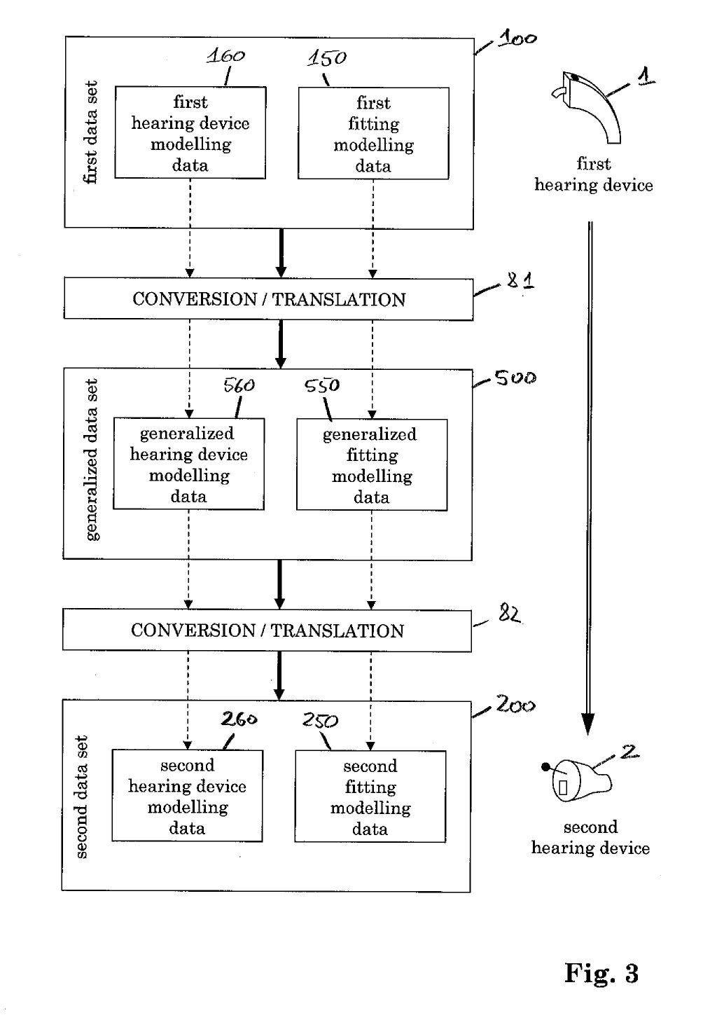

FIG. 3 shows a diagrammatical illustration of a method and an apparatus. The process shown in FIG. 3 can be fully or partially (e.g., with only one conversion step, 81 or 82) implemented in a fitting transfer unit (cf. FIG. 1) or separately therefrom.

FIG. 3 illustrates that a fitting transfer can be carried out making use of a generalized data structure or of a special fitting description language, in particular which is suited for the purpose of providing a unified way of transferring fittings from a first hearing device 1 to a second hearing device 2.

Data with respect to first hearing device 1 and its fitting are in first data set 100, the data structure (or format) of which usually will be rather specific for first hearing device 1 and/or the first fitting system.

Since, in the end, one usually wants to have a second data set 200 in a data structure (or format) specific for second hearing device 2 and/or the second fitting system, one will have to provide at least one conversion anyway. But proceeding like this would require a huge number of converters (or corresponding conversion algorithms) when all different conversions from one hearing device to another shall be possible for a large number of hearing devices.

This situation is simplified by introducing said generalized data structure or said special fitting description language. Through this, data structures from any combination of hearing device and fitting system only have to be converted into and out of that generalized data structure or fitting description language.

Accordingly, firstly, data set 100 is converted (ref. 81) into generalized data set 500 having at least approximately the same informational content, and then, data set 500 is converted (ref. 82) into data set 200 also having at least approximately the same informational content as data set 100. Data sets 100, 200 and 500 each have a structure as shown in FIG. 2.

Of course, as indicated by the dashed arrows in FIG. 3, it is also possible to treat hearing device modelling data and fitting modelling data separately. In this case, it is even possible to use a hearing device modelling description language for hearing device modelling data and a fitting system modelling description language for fitting system modelling data, which may be different from or identical with each other. And each of these languages may be different from or identical with said fitting description language.

It is possible to provide that the depicted languages or at least one of them is substantially representing a tree structure, in particular wherein many parent and child nodes are realized in such a way that the parent node comprises information indicative of the nature of a parameter, a first child node comprises information indicative of the possible range of that parameter, and a second child node comprises information indicative of the actual setting of that parameter.

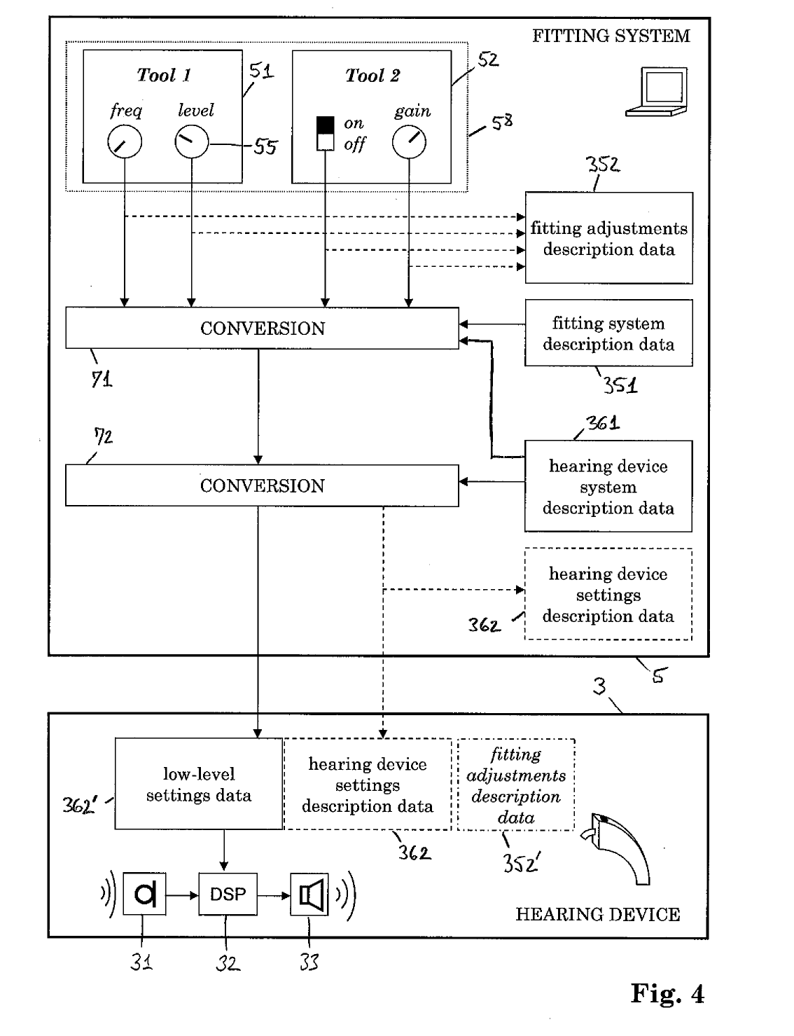

FIG. 4 shows a diagrammatical illustration of a method and an apparatus. It illustrates, how a hearing device such as first hearing device 1 can be fitted, and where data discussed above may occur or be generated.

In FIG. 4, it is illustrated how a hearing device 3 is fitted (to the needs and preferences of a specific hearing device user) using a fitting system 5, the latter being assumed to be a computer and a fitting software executed therein.

A fitting system user interface 58 allows to visualize and adjust fitting modifiers such as fitting modifier 55 usually arranged in tools such as tools 51, 52. The output of such a fitting modifier 55 (e.g., value=45 in a scale of 0 to 100) has to be linked to a meaning the adjustment shall have. This is accomplished by converter 71 which for this purpose receives as its inputs data 351 and data 361. Data 351 gives a meaning to the adjustment, such as indicating that a compression ratio is modified in the selected way, and for some parameters, it can be required to receive also data 361, e.g., if the adjusted parameter is related to frequency bands, it may be necessary to know at this point, how many frequency bands hearing device 3 offers.

Then, another conversion (ref. 72) takes place, in dependence of data 361, in which the before-derived data are converted in a form “understandable” by hearing device 3, such as low-level data 362′, e.g., in binary form. Preferably, a higher-level representation of the data is generated a well, namely data 362, which may be stored in hearing device 3 and/or in fitting system 5.

The information comprised in data 362′ and 362, respectively, is required by hearing device 3 for its operation. Neither data 352 nor data 352′ are required by hearing device 3 for its operation. Data 352′ may be, with respect to their information contents, identical with data 352 or represent a portion thereof. Nevertheless, if data 352′ are stored in hearing device 3, this can be valuable, in particular when a fitting transfer to another hearing device shall at some point be carried out.

In FIG. 4, some standard components of hearing device 3 are depicted as well: an input transducer 31 for receiving input signals and generating an output of audio signals processable by signal processor 32, and an output transducer 33 for converting the processed audio signals into signals to be perceived by the hearing device user. Furthermore, also a controller will typically be provided in hearing device 3; the latter as well as signal processor 32 are operated in accordance with data 362′.

It is possible to provide that the conversion of ref. 72 is carried out in hearing device 3. And it is, in addition possible to provide that the conversion of ref. 71 is carried out in hearing device 3.

The outputs of the fitting modifiers of fitting system 5 are, as indicated by the four parallel dashed arrows, read into data 352.

Accordingly: If the fitting of the first hearing device has taken place in the way described in FIG. 4, data 351, 352, 361 and 362 are readily available, cf. also FIG. 2. Considering the wish to transfer that fitting to a second hearing device, also the corresponding data 351 and 361 for the second hearing device will usually be readily available, cf. also FIG. 2. Therefore, largely enough input is readily available for transferring the fitting from the first to the second hearing device, and more particularly for determining the corresponding (user-specific) data (data 352 and 362) for the second hearing device and second fitting system (cf. FIG. 2; data 352 and 362 corresponding to data 252 and 262 in FIG. 1).

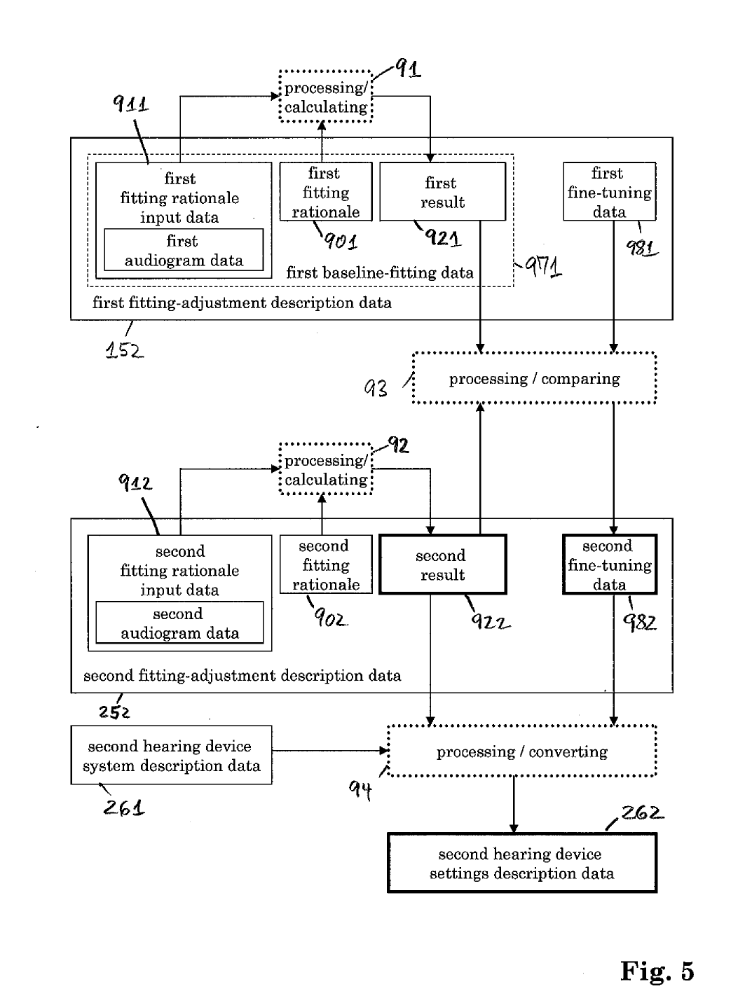

FIG. 5 shows a diagrammatical illustration of a method and an apparatus. This figure illustrates relatively concretely and in detail, how the fitting transfer can be accomplished. More particularly, it illustrates, how data 252, more particularly data 922 and 982, and data 262 can be derived from data 152 and 261. It can be provided to carry out all what is shown in FIG. 5 or a portion thereof in a fitting transfer unit 40 (cf. FIG. 1) and/or in a fitting system. All this or—today rather—a portion thereof can be carried out in a hearing device.

We shall begin with the first hearing device and the first fitting system.

As has been pointed out earlier in this patent application, it is common to start with a baseline-fitting which is basically based on the effectivity of a fitting rationale and diagnostic data inputted thereto.

For this reason, data 152 are illustrated to comprise first baseline fitting data 971 and, in addition, usually making up for all the remainder of information in data 152, first fine-tuning data 981. Data 971 may comprise data 921 (“first result”). Or, data 971 comprise data 911 and data 901, wherein regarding data 901, it is actually sufficient to have data indicative of name and version of the first fitting rationale, since therewith one can retrieve the actual fitting rationale.

Assuming that data 911 and 901 are provided, the algorithm of the rationale can be applied (ref. 91), and data 921 are readily obtained.

With respect now, to the determination of data 252 (regarding the second hearing device and its fitting), we now want to have data 252 also in such a form that we have baseline fitting data, more particularly data 922 (“second result”), and in addition thereto. second fine-tuning data 982. A good reason to do so is that fitting modifiers (cf. FIG. 4) usually depend on the baseline fitting, in that sense that they work relative to values given by the baseline fitting. Accordingly, we will be able to properly and comfortably use the second fitting system for carrying out even further adjustments, when we determine both, data 922 and data 982, and not only so-to-speak their sum, i.e. data 252. From data 252, one certainly can obtain good settings of the second hearing device (data 262). But with data 922 and 982 derived as explained above, we obtain valuable data 252.

Therefore, data 922 will be determined (ref. 92), e.g., using the second fitting system, new data 912, e.g., comprising second audiogram data, and another fitting rationale (data 902).

Having done so, we can, based on data 971, 981 and 922, determine the second fine-tuning data (data 982). This preferably involves a comparison of first result 921 and second result 922.

Then, from data 922 and data 982, and in dependence of data 261 (comparable to data 361 in FIG. 4), data 262 will be derived (ref. 94). For this step, it would not be necessary to have data 922 and data 982 in this separated form, but data 252 as fitting adjustment description data not distinguishing baseline fitting (cf. ref. 922) and fine-tuning (cf. ref. 982) would be sufficient.

If one would not be interested in having a properly adjusted second fitting system, one could dispense with calculating data 252 and, earlier, dispense also with distinguishing data 971 and data 981 within data 152. In this case, one could obtain a well-adjusted second hearing device, but not an adjusted second fitting system which would allow to readily carry out further optimizations.

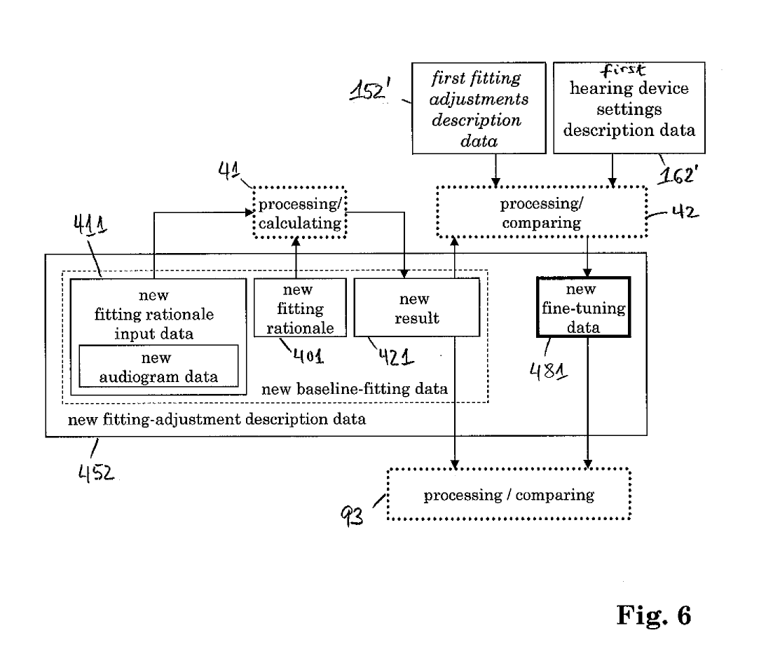

FIG. 6 shows a diagrammatical illustration of a detail of a method and an apparatus. It illustrates a different version of the upper portion of FIG. 5, down to the processing of ref. 93, namely for the case that—in FIG. 5—data 921 are not available and at least one of data 911 and data 901 are not available.

In order to nevertheless be able to generate baseline-fitting data and fine-tuning data, which is very useful for the reasons mentioned above, it is possible to generate these, e.g., in the way shown in FIG. 6.

On the one hand, one derives a new baseline fitting, namely by applying a new fitting rationale (data 401) to new fitting rationale input data (data 411). Therein, possibly one of these (data 401 or data 411) may be identical with the corresponding data of the first hearing device/first fitting system (data 901 and data 911 in FIG. 5). Thus, one derives a new result (data 421).

Based on first hearing device settings description data 162′ and, preferably (optionally), also on first fitting adjustments description data 152′, and, preferably (optionally), also on first fitting system description data (not shown in FIG. 6), one can derive, making a comparison step comparing with data 421, new fine-tuning data 481.

With feeding data 421 and 481 to the processing (ref. 93), one can then proceed as shown in FIG. 5, also at ref. 93.

Aspects of the embodiments have been described in terms of functional units. As is readily understood, these functional units may be realized in virtually any number of hardware and/or software components adapted to performing the specified functions.

### LIST OF REFERENCE SYMBOLS

1 first hearing device
2 second hearing device
3 hearing device
5 fitting system
31 input converter, microphone
32 signal processor
33 output converter, loudspeaker
40 fitting transfer unit
41 processor
42 processor
51 tool, software fitting tool
52 tool, software fitting tool
55 fitting modifier
58 fitting system user interface
71 converter, processor
72 converter, processor
81 converter, translator, processor
82 converter, translator, processor
91 processor
92 processor
93 processor
94 processor
100 first data set
150 first fitting modelling data
152 first fitting adjustments description data
152′ first fitting adjustments description data
155 data related to first fitting system
160 first hearing device modelling data
162′ first hearing device settings description data
165 data related to first hearing device
200 second data set
250 second fitting modelling data
251 second hearing device system description data
252 second fitting adjustments description data
260 second hearing device modelling data
261 second hearing device system description data
262 second hearing device settings description data
290 user-specific data
290 non-user-specific data
300 data set
350 fitting modelling data
351 fitting system description data
352 fitting adjustments description data
352′ fitting adjustments description data
360 hearing device modelling data
361 hearing device system description data
362 hearing device settings description data
362′ low-level settings data
401 new fitting rationale
411 new fitting rationale input data
421 new result
452 new fitting adjustments description data
481 new fine-tuning data
500 generalized data set
550 generalized first fitting modelling data
560 generalized first hearing device modelling data
901 first fitting rationale
902 second fitting rationale
911 first fitting rationale input data
912 first fitting rationale input data
921 first result
922 second result
971 first baseline-fitting data
981 first fine-tuning data
982 second fine-tuning data

1. Method for manufacturing an adjusted second hearing device adjusted in dependence of a first hearing device, wherein said first hearing device has been, by means of a first fitting system, individually adjusted to needs and preferences of a specific hearing device user, said method comprising the steps of
a1) providing data related to said first hearing device;
a2) providing data related to said first fitting system;
d1′) adjusting said second hearing device in dependence of said data related to said first hearing device and of said data related to said first fitting system.

2. The method according to claim 1, wherein a second fitting system is used for adjusting said second hearing device, said method further comprising the step of
d2′) adjusting said second fitting system in dependence of said data related to said first hearing device and of said data related to said first fitting system.

3. The method according to claim 1 or claim 2, wherein said data related to said first hearing device comprise data descriptive of hearing device parameter settings of said first hearing device individually adjusted for said specific hearing device user and, in addition, data descriptive of properties of said first hearing device which are not individual to said specific hearing device user.

4. The method according to one of the preceding claims, wherein said data related to said first fitting system comprise data descriptive of fitting system parameter adjustments carried out during adjusting said first hearing device using said first fitting system and, in addition, data descriptive of properties of said first fitting system which are not individual to said specific hearing device user.

5. The method according to one of the preceding claims, wherein a second fitting system is used for adjusting said second hearing device, said method comprising the steps of
a) providing a first data set comprising first hearing device modelling data and first fitting modelling data;
wherein said first hearing device modelling data comprise
first hearing device settings description data descriptive of hearing device settings, in particular parameter settings, of said first hearing device individually adjusted for said specific hearing device user; and, in addition,
first hearing device system description data descriptive of properties, in particular of hardware and software properties, of said first hearing device which are not individual to said specific hearing device user; and
wherein first fitting modelling data comprise
first fitting-adjustments description data descriptive of fitting system parameter adjustments carried out during adjusting said first hearing device using said first fitting system; and, in addition,
first fitting system description data descriptive of properties of said first fitting system which are not individual to said specific hearing device user;
b1) providing second hearing device system description data descriptive of properties, in particular of hardware and software properties, of said second hearing device which are not individual to said specific hearing device user;
b2) providing second fitting system description data descriptive of properties of said second fitting system which are not individual to said specific hearing device user;
c1) deriving, in dependence of
said first data set;
said second hearing device system description data; and
said second fitting system description data;
second hearing device settings description data descriptive of hearing device settings, in particular parameter settings, applicable to said second hearing device; and
d1) adjusting said second hearing device according to said second hearing device settings description data.

6. The method according to claim 5, comprising the steps of
c2) deriving, in dependence of
said first data set;
said second hearing device system description data; and
said second fitting system description data;
second fitting-adjustments description data descriptive of fitting system parameter adjustments applicable to said second fitting system; and
d2) carrying out adjustments of said second fitting systems according to said second fitting-adjustments description data.

7. The method according to claim 6, comprising the steps of
e1) creating second hearing device modelling data comprising said second hearing device settings description data and said second hearing device system description data;
e2) creating second fitting modelling data comprising said second fitting-adjustments description data and said second fitting system description data;
f) creating a second data set comprising said second hearing device modelling data and said second fitting modelling data; and
d) carrying out adjustments of said second fitting system in dependence of said second data set.

8. The method according to one of claims 5 to 7, wherein said first data set is written in a fitting description language which is a computer language by means of which fitting processes and environments are describable in a generalized way.

9. The method according to claim 8, comprising the step of
g) obtaining said first data set written in said fitting description language from a corresponding data set having a different data structure or data format characteristic for said first hearing device and/or for said first fitting system.

10. The method according to one of claims 5 to 9, wherein data in said first data set are logically arranged in a tree structure.

11. The method according to one of claims 5 to 10, wherein said first fitting-adjustments description data comprise first baseline-fitting data and, in addition, first fine-tuning data, wherein said baseline-fitting data are obtained by applying a fitting rationale to first fitting-rationale input data, and wherein said first fine-tuning data are descriptive of additional fitting system parameter adjustments carried out during adjusting said first hearing device using said first fitting system after applying said baseline-fitting data.

12. The method according to claim 11, wherein said first baseline-fitting data comprise at least one of the group consisting of
first fitting rationale input data and data descriptive of a first fitting rationale applied to said first fitting rationale input data during adjusting said first hearing device; and
data descriptive of a first result obtained, during fitting said first hearing device, by applying a first fitting rationale to first fitting rationale input data;
the method comprising the steps of
j) applying a second fitting rationale to second fitting rationale input data, obtaining a second result; and
k) comparing said first result with said second result;
wherein said second hearing device settings description data depend on the result of said comparison, and wherein said second fitting rationale is either identical with or different from said first fitting rationale, and wherein said second fitting rationale input data are either identical with or different from said first fitting rationale input data.

13. The method according to claim 12, comprising the steps of
c2′) deriving, in dependence of
said first data set;
said second hearing device system description data;
said second fitting system description data; and
said result of said comparison;
second fitting-adjustments description data descriptive of fitting system parameter adjustments applicable to said second fitting system; and
d2) carrying out adjustments of said second fitting systems according to said second fitting-adjustments description data.

14. Apparatus for adjusting a second hearing device in dependence of a first hearing device, wherein said first hearing device has been, by means of a first fitting system, individually adjusted to needs and preferences of a specific hearing device user, said apparatus comprising a fitting transfer unit structured and configured for
receiving data related to said first hearing device;
receiving data related to said first fitting system; and
deriving, in dependence of said data related to said first hearing device and said data related to said first fitting system, second hearing device settings description data descriptive of hearing device settings applicable to said second hearing device, in particular parameter settings for said said second hearing device.

15. The apparatus according to claim 14, wherein said fitting transfer unit is structured and configured for
outputting said second hearing device settings description data;
and in particular structured and configured for
outputting said second hearing device settings description data to said second hearing device.

16. The apparatus according to claim 14 or claim 15, wherein said fitting transfer unit is structured and configured for
i) receiving a first data set comprising first hearing) device modelling data and first fitting modelling data;
wherein said first hearing device modelling data comprise
first hearing device settings description data descriptive of hearing device settings, in particular parameter settings, of said first hearing device individually adjusted for said specific hearing device user; and, in addition,
first hearing device system description data descriptive of properties, in particular of hardware and software properties, of said first hearing device which are not individual to said specific hearing device user; and
wherein first fitting modelling data comprise
first fitting-adjustments description data descriptive of fitting system parameter adjustments carried out during adjusting said first hearing device using said first fitting system; and, in addition,
first fitting system description data descriptive of properties of said first fitting system which are not individual to said specific hearing device user;
ii) receiving second hearing device system description data descriptive of properties, in particular of hardware and software properties, of said second hearing device which are not individual to said specific hearing device user;
iii) receiving second fitting system description data descriptive of properties of a second fitting system suitable for adjusting said second hearing device, wherein said second fitting system description data are not individual to said specific hearing device user;
iv) deriving said second hearing device settings description data in dependence of
said first data set;
said second hearing device system description data; and
said second fitting system description data.

17. The apparatus according to claim 16, comprising said second fitting system.

18. Computer program product comprising program code for causing a computer to perform the steps of
A1) providing or receiving data related to a first hearing device;
A2) providing or receiving data related to a first fitting system, wherein said first hearing device has been, by means of said first fitting system, individually adjusted to needs and preferences of a specific hearing device user; and
C) deriving, in dependence of said data related to said first hearing device and of said data related to said first fitting system, second hearing device settings description data descriptive of hearing device settings applicable to a second hearing device, in particular parameter settings for said said second hearing device.

19. The computer program product according to claim 18, wherein said program code is configured to cause said computer to perform the step of
D1) adjusting said second hearing device in dependence of said second hearing device settings description data.

20. Computer-readable medium comprising program code as described in claim 18 or claim 19.

21. Use of data related to a first fitting system, in particular of data descriptive of properties of said first fitting system, for determining data for adjusting a second hearing device, wherein said first hearing device has been, by means of a first fitting system, individually adjusted to needs and preferences of a specific hearing device user.

22. The use according to claim 21, wherein said data related to said first fitting system comprise data descriptive of fitting system parameter adjustments carried out during adjusting said first hearing device using said first fitting system.
